(19) United States
(12) Patent Application Publication
(10) Pub. No.: US 2002/0103331 A1
(43) Pub. Date: Aug. 1, 2002

(54) Process for increasing the molar mass of a cationic acryloyloxyethyltrimethylammonium chloride copolymer, and corresponding copolymers

(75) Inventors: Jean-Luc Zeh, Spicheren (FR); Lionel Sabatier, Gouvieux (FR); Stephane Lepizzera, Saint-Avold (FR)

Correspondence Address: MILLEN, WHITE, ZELANO & BRANIGAN, P.C., 2200 CLARENDON BLVD., SUITE 1400, ARLINGTON, VA, 22201, US

(73) Assignee: ATOFINA, Puteaux (FR)

(21) Appl. No.: 09/971,055

(22) Filed: Oct. 5, 2001

(30) Foreign Application Priority Data
Oct. 5, 2000 (FR) 0012730

(51) Int. Cl. C08G 73/00

(52) U.S. Cl. 528/422

(57) ABSTRACT

A process for increasing the molar mass of a cationic copolymer of the unsaturated quaternary ammonium salt of formula (I):

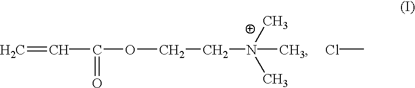

(ADAMQUAT MC), is characterized in that a monomer of formula (I) is used which has a concentration of its dimer of formula (II):

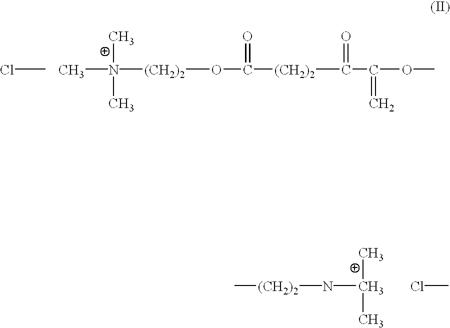

of less than 2000 ppm.

The present invention relates to a process for increasing the molar mass of a cationic acryloyl-oxyethyltrimethylammonium chloride (ADAMQUAT MC) copolymer. It also relates to the corresponding cationic copolymers having increased molar masses.

Cationic copolymers find industrial application in various fields, such as water treatment, paper making, where they are used as retention agents, and so on. In all of these applications, the use of a high-mass cationic copolymer makes it possible to enhance the efficacy of the said copolymer (enhancement of its role as flocculant, improved retention of paper fibres) and to reduce the proportion in which it is added.

The molar mass of cationic copolymers may be controlled by virtue inter alia of the type of process used, the polymerization kinetics, the nature and purity of the comonomer, or else the addition of crosslinking agents. The influence of these parameters on the molar mass of the copolymers is now known and has been the subject of patents. On the other hand, although it is widely acknowledged that the purity of ADAMQUAT MC may have a considerable influence on the molar mass of cationic copolymers, there are at present no precise data enabling the molar mass of the copolymers to be correlated with the impurities of the ADAMQUAT MC.

The applicant company has now discovered surprisingly that it is possible to obtain cationic copolymers of high molar mass by virtue of precise control of the purity of the ADAMQUAT MC, having shown that, among the various impurities of ADAMQUAT MC, the presence of the dimer of formula:

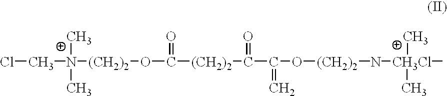

brings about a significant reduction in the molar mass of the copolymers at concentrations greater than 1000-2000 ppm.

The present invention accordingly provides a process for increasing the molar mass of a cationic copolymer of the unsaturated quaternary ammonium salt of formula (I):

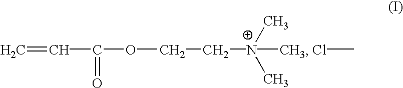

(ADAMQUAT MC), characterized in that a monomer of formula (I) is used which has a concentration of its dimer of formula (II):

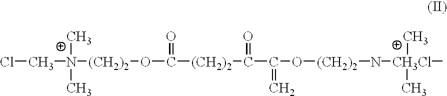

of less than 2000 ppm, in particular less than 1000 ppm.

The use of a monomer (I) having such a purity makes it possible to increase the viscosity of an aqueous solution of the cationic copolymers by at least 30% relative to copolymers manufactured with a monomer (I) of customary purity under the same polymerization conditions (same process, same comonomers, same proportion of comonomers).

The present invention therefore makes it possible to obtain cationic copolymers of high molar mass, with molar masses which are in any case increased relative to those of copolymers manufactured with the monomers (I) of customary purity.

Upon further study of the specification and appended claims, other aspects of the invention will become apparent.

The monomer of formula (I) has been prepared in particular by reacting N,N-dimethylaminoethyl acrylate (ADAME) with the quaternizing agent CH₃Cl in the presence of water, the said reaction having been conducted in a closed reactor containing all of the ADAME and having been pressurized with air or with depleted air at from 0.5 to 3 bar, by continuous introduction at a temperature of from 35 to 65° C. of CH₃Cl on the one hand and water on the other until the desired concentration of the target salt in the water was obtained, the introduction of the water having been commenced when 0-20% of the ponderal amount of CH₃Cl required for the reaction had been added, and the pressure at the end of the reaction having been able to attain 9 bar, after which the reactor had been depressurized while maintaining a constant oxygen content by simultaneous introduction of air, and the residual CH₃Cl having been removed following return to atmospheric pressure.

In accordance with preferred features of this process:

the quaternizing agent is introduced over a period of 1-7 hours and the water over a period of 2-8 hours;

the reaction is conducted with a molar ratio of the quaternizing agent to the ADAME of from 1 to 1.1, preferably from 1 to 1.05;

the reaction is conducted with an average ratio of water/quaternizing agent flow rate of 0.1-1.2, in particular 0.3-0.8.

Moreover, this process may be conducted in the presence of at least one stabilizer which may be selected from 3,5-di-tert-butyl-4-hydroxytoluene, hydroquinone methyl ether, hydroquinone, catechol, tert-butylcatechol, phenothiazine, and mixtures of these stabilizers, the stabilizer content being in particular from 20 to 2000 ppm, preferably from 100 to 1200 ppm, relative to the aqueous solution of quaternary salt (I).

It is also possible to add at least one metal sequestrant to the reaction mixture, selected in particular from diethylenetriaminepentaacetic acid, the pentasodium salt of diethylenetriaminepentaacetic acid, N-hydroxy-ethylethylenediaminetriacetic acid and the trisodium salt of N-hydroxyethylethylenediaminetriacetic acid, the sequestrant content being in particular from 1 to 100 ppm, preferably from 5 to 30 ppm, relative to the aqueous solution of quaternary salt (I).

Generally speaking, the sequestrants are added in the form of an aqueous solution, since they are generally available in this form. For instance, the pentasodium salt of diethylenetriaminepentaacetic acic, sold under the name VERSENEX 80, is in the form of an approximately 40% strength by weight aqueous solution.

The present invention additionally provides a cationic copolymer obtained from a monomer composition comprising a monomer of formula (I):

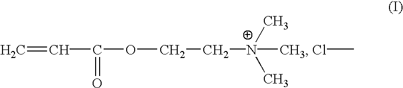

(ADAMQUAT MC) which has a concentration of its dimer of formula (II):

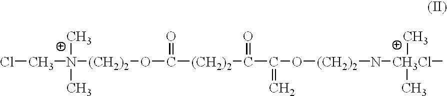

of less than 2000 ppm.

The monomer (I) is preferably that prepared by the process described above.

Cationic copolymers according to the present invention are preferably those obtained from a monomer composition comprising per 100 parts by weight:

(1) up to 60 parts by weight, in particular from 5 to 60 parts by weight, of the monomer of formula (I) as defined above with one or more of the following monomers;

(2) from 0 to 80 parts by weight of at least one monomer of formula (III):

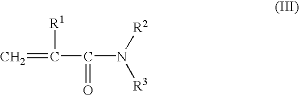

in which:

R¹ represents H or —CH₃; and

R² and R³, identical or different, each represent H or C₁-C₅ alkyl;

(3) from 0 to 50 parts by weight of at least one monomer of formula (IV):

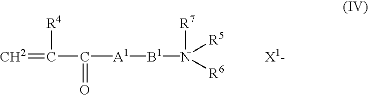

in which:

R⁴ represents H or —CH₃; and

A¹ represents —O— or —NH—;

B¹ represents —CH₂—CH₂—, —CH₂CH₂CH₂—, CH₂—CHOH—CH₂—;

R⁵ and R⁶ each independently represent —CH₃ or —CH₂CH₃;

R⁷ represents H, —CH₃, —CH₂CH₃ or —CH₂—C₆H₅;

X¹— represents a monovalent anion, such as Cl—, SCN—, CH₃SO₃— and Br—,

to the exclusion of compound of formula (I);

(4) from 0 to 50 parts by weight of at least one monomer of formula (V):

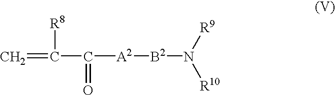

in which:

R⁸ represents H or —CH₃;

A² represents —O— or —NH—;

B² represents —CH₂—CH₂—, —CH₂CH₂CH₂—, —CH₂—CHOH—CH₂—;

R⁹ and R¹⁰ each independently represent —CH₃ or —CH₂CH₃;

(5) from 0 to 80 parts by weight of at least one monomer having a carboxyl function.

By way of examples of monomers of formula (III), mention may be made of acrylamide, methacrylamide, N-methylacrylamide and N,N-dimethylacrylamide.

By way of examples of monomers of formula (IV), mention may be made of:

methacryloxyethyldimethylbenzylammonium chloride (MADQUAT BZ);

methacryloxyethyltrimethylammonium chloride (MADQUAT MC); and

acryloxyethyldimethylbenzylammonium chloride (ADAMQUAT BZ).

By way of examples of monomers of formula (V), mention may be made of dimethylaminopropylacrylamide (DMAPAA) and dimethylaminopropylmethacrylamide (DMAPMA).

By way of example of monomers (E), mention may be made of acrylic acid, methacrylic acid and itaconic acid.

The preparation of the copolymers of the present invention is a conventional preparation, in accordance with the gel process or the inverse emulsion process.

the gel process consists in performing the polymerization in an aqueous solution in which the monomers and polymers are soluble and in obtaining a gel at the end of polymerization; this gel is subsequently dried and ground to give a ready-to-use powder;

the inverse emulsion process consists in performing the polymerization using a disperse aqueous phase containing the water-soluble polymers and monomers, and a continuous oily phase. After polymerization, the inverse emulsion obtained is inverted to give a viscous aqueous solution containing the polymer, which is ready to use.

The examples which follow illustrate the present invention without, however, limiting its scope. In these examples, percentages are by weight unless indicated otherwise.

### EXAMPLE 1

Synthesis of a High-Purity ADAMQUAT MC

A 1 l jacketed glass reactor specially designed to withstand pressure and equipped with a temperature probe, a gas/liquid specific stirrer (turbine with a hollow shaft), a valve tared at 10 bar, a bursting disc and dip pipes for the introduction of the various reactants was charged with 429 g of ADAME. The reactor was closed and then pressurized with 1 bar of depleted air. Stirring and heating were begun.

As soon as the temperature reached 40° C. (process temperature: 47° C.), the introduction of CH₃Cl was commenced at a rate of 159 g/h. When 15 g of CH₃Cl had been added, equivalent to 10% of the stoichiometry in terms of CH₃Cl, the introduction of water was commenced at a rate of 60 g/h, while maintaining the addition of CH₃Cl. The H₂O/CH₃Cl flow rate ratio was held constant at 0.37 for the entire duration of the reaction.

When all of the water had been introduced (namely 1473 g), the reactor was brought back to atmospheric pressure using the following protocol:

degassing of the excess CH₃Cl for 30 minutes with simultaneous introduction of air into the charge (flow rate: 3 l/h (STP));

gradual return to atmospheric pressure.

Traces of CH₃Cl were subsequently removed by stripping with air (flow rate: 5 l/h (STP)) for 30 minutes. The reactor was subsequently cooled and then emptied.

The durations of the different phases of the reaction were as follows:

| | |
|---|---|
| introduction ot CH₃Cl: | 1 h |
| introduction of H₂O: | 2.3 h |
| degassing: | 0.5 h |
| stripping: | 0.5 h |

i.e. a total duration of approximately 3.5 h

The crude reaction mixture (716 g) was analysed by high-performance liquid chromatography (HPLC) in order to determine the amount of dimer (formula II) in the ADAMQUAT MC, which was 100 ppm.

### EXAMPLE 2

Synthesis of a Conventional-Purity ADAMQUAT MC

The procedure of Example 1 was repeated except that the CH₃Cl was introduced over 7 h.

The crude reaction mixture (716 g) was analysed by high-performance liquid chromatography (HPLC) in order to determine the amount of dimer (formula II) in the ADAMQUAT MC, which was 3000 ppm.

### EXAMPLE 3

Manufacture of a Comparative Cationic Copolymer (Gel Process)

The ADAMQUAT MC 80 manufactured in accordance with Example 2 is polymerized by the gel process.

The polymerization is conducted as follows: 48 g of solid acrylamide are dissolved in 180 g of water. 60 g of the ADAMQUAT MC 80 are then added to this solution. The mixture thus prepared is subsequently placed in an adiabatic vessel of the Dewar type. Finally, 0.005 g of ammonium persulphate and 0.005 g of sodium metabisulphite are added in order to initiate the polymerization at ambient temperature. The gel obtained at the end of polymerization is subsequently ground and dried. The weight-average molar mass of the copolymer is estimated by measuring the viscosity of a molar aqueous NaCl solution containing 0.1% of this cationic copolymer using a Brookfield instrument (DV-II, rotational speed=60 rpm, temperature=20° C.).

The viscosity of the molar NaCl solution containing 0.1% of the cationic copolymer manufactured using the ADAMQUAT MC 80 of Example 2 is 2.6 cps.

### EXAMPLE 4

Manufacture of a Cationic Copolymer in Accordance with the Invention (Gel Process)

A cationic copolymer was synthesized by the process described in Example 3 using the ADAMQUAT MC 80 synthesized in accordance with Example 1.

The viscosity of the molar NaCl solution containing 0.1% of the cationic copolymer manufactured with the ADAMQUAT MC 80 of Example 1 is 3.6 cps.

### EXAMPLE 5

Manufacture of a Comparative Cationic Copolymer (Inverse Emulsion Process)

The ADAMQUAT MC 80 manufactured in accordance with Example 2 is polymerized by the process of inverse emulsion polymerization.

The aqueous phase is prepared by mixing 335.9 g of 50% acrylamide, 50 g of ADAMQUAT MC 80, 1.68 g of 50% NaOH, 12.6 g of NaCl and 0.08 g of ethylenediaminetetraacetic acid (EDTA) in 176.35 g of water.

The oil phase is prepared by mixing 218.67 g of isoparaffinic hydrocarbons sold by the company Exxon Chemical under the name Isopar M, 18.6 g of sorbitan monooleate and 2.2 g of polyoxyethylenated sorbitan monooleate. The oil phase is heated at 40° C. with stirring in order to facilitate dissolution.

The emulsion is then prepared by mixing the oil phase and aqueous phase using an Ultra-Turrax® mixer at 10000 rpm for 2 minutes.

The emulsion is subsequently transferred to a jacketed glass reactor equipped with a condenser, a central stirrer and a nitrogen introduction means. The emulsion is heated to 46° C. with stirring at 800 rpm and is purged with nitrogen for 20 minutes. After this time has elapsed, 0.21 g of azobisisobutyronitrile is introduced into the reactor. An exothermic reaction is then observed and, when the temperature of the mixture returns to 46° C., it is heated at 54° C. for 1 h, then again at 57° C. for 30 minutes, and finally a third time at 78° C. for 2 h.

The emulsion is subsequently cooled and filtered.

The inversion of this emulsion is carried out as follows: 0.125 g of polyethoxylated nonylphenol is added to 490 g of water and mixed with an Ultra-Turrax® mixer. 10 g of the emulsion are injected slowly into this aqueous solution with stirring using the Ultra-Turrax® mixer. The inverted solution thus obtained is left to stand for 24 h.

The average molar mass of the copolymer is estimated by measuring the viscosity of the inverted solution using a Brookfield apparatus (ERV8, rotational speed=50 rpm, rotor 2, temperature=20° C.).

The viscosity of the inverted aqueous solution of the cationic copolymer manufactured with the ADAMQUAT MC 80 of Example 2 is 250 cps.

### EXAMPLE 6

Manufacture of a Cationic Copolymer in Accordance with the Invention (Inverse Emulsion Process)

A cationic copolymer was synthesized by the process described in Example 5 using the ADAMQUAT MC 80 synthesized in accordance with Example 1.

The viscosity of the inverted aqueous solution of the cationic copolymer manufactured with the ADAMQUAT MC 80 of Example 1 is 530 cps.

Whereas it is possible that other methods of production and/or purification of ADAMQUAT MC may be utilized, in the future, it will be necessary to measure the amount of the dimer of formula (II) in the product so as to determine whether the concentration of said dimer is less than 2000 ppm, preferably less than 1000 ppm (by weight) of the ADAMQUAT MC product. If the amount of dimer is found to comply with the aforesaid upper limit of less than 2000 ppm then the ADAMQUAT MC can be copolymerized.

The preceding examples can be repeated with similar success by substituting the generically or specifically described reactants and/or operating conditions of this invention for those used in the preceding examples. Also, the preceding specific embodiments are to be construed as merely illustrative, and not limitative of the remainder of the disclosure in any way whatsoever.

The entire disclosure of all application, patents and publications, cited above and below, and of corresponding French application 00/12.730, are hereby incorporated by reference.

From the foregoing description, one skilled in the art can easily ascertain the essential characteristics of this invention, and without departing from the spirit and scope thereof, can make various changes and modifications of the invention to adapt it to various usages and conditions.

1. - Process for increasing the molar mass of a cationic copolymer of the unsaturated quaternary ammonium salt of formula (I): 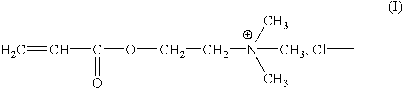
(ADAMQUAT MC), characterized in that a monomer of formula (I) is used which has a concentration of its dimer of formula (II): 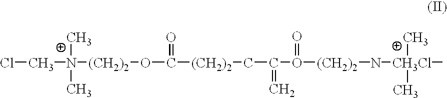
of less than 2000 ppm.

2. - Process according to claim 1, characterized in that a monomer of formula (I) is used which has a concentration of its dimer of formula (II) of less than 1000 ppm.

3. - Process according to one of claims 1 and 2, characterized in that a monomer of formula (I) is used which has been prepared by reacting N,N-dimethylaminoethyl acrylate (ADAME) with the quaternizing agent CH₃Cl in the presence of water, the said reaction having been conducted in a closed reactor containing all of the ADAME and having been pressurized with air or with depleted air at from 0.5 to 3 bar, by continuous introduction at a temperature of from 35 to 65° C. of CH₃Cl on the one hand and water on the other until the desired concentration of the target salt in the water was obtained, the introduction of the water having been commenced when 0-20% of the ponderal amount of CH₃Cl required for the reaction had been added, and the pressure at the end of the reaction having been able to attain 9 bar, after which the reactor had been depressurized while maintaining a constant oxygen content by simultaneous introduction of air, and the residual CH₃Cl having been removed following return to atmospheric pressure.

4. - Cationic copolymer characterized in that it has been obtained from a monomer composition comprising a monomer of formula (I): 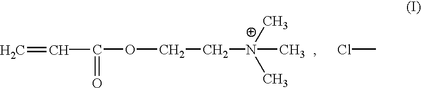
(ADAMQUAT MC) having a concentration of its dimer of formula (II): 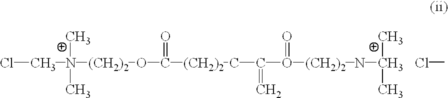
of less than 2000 ppm.

5. - Cationic copolymer according to claim 4, characterized in that the monomer of formula (II) has a concentration of its dimer (II) of less than 1000 ppm.

6. - Cationic copolymer according to one of claims 4 and 5, characterized in that the monomer of formula (I) has been prepared by reacting N,N-dimethylaminoethyl acrylate (ADAME) with the quaternizing agent CH₃Cl in the presence of water, the said reaction having been conducted in a closed reactor containing all of the ADAME and having been pressurized with air or with depleted air at from 0.5 to 3 bar, by continuous introduction at a temperature of from 35 to 65° C. of CH₃Cl on the one hand and water on the other until the desired concentration of the target salt in the water was obtained, the introduction of the water having been commenced when 0-20% of the ponderal amount of CH₃Cl required for the reaction had been added, and the pressure at the end of the reaction having been able to attain 9 bar, after which the reactor had been depressurized while maintaining a constant oxygen content by simultaneous introduction of air, and the residual CH₃Cl having been removed following return to atmospheric pressure.

7. - Cationic copolymer according to one of claims 1 to 6, characterized in that it has been obtained from a monomer composition comprising per 100 parts by weight:
(3) up to 60 parts by weight of the monomer of formula (I) as defined in one of claims 4 to 6;
(4) from 0 to 80 parts by weight of at least one monomer of formula (III): 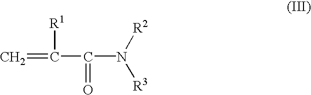
in which:
R¹ represents H or —CH₃; and
R² and R³, identical or different, each represent H or C₁-C₅ alkyl;
(4) from 0 to 50 parts by weight of at least one monomer of formula (IV): 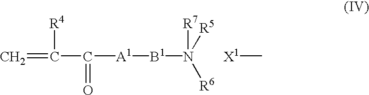
in which:
R⁴ represents H or —CH₃; and
A¹ represents —O— or —NH—;
B¹ represents —CH₂—CH₂—, —CH₂CH₂CH₂—, CH₂—CHOH—CH₂—;
R⁵ and R⁶ each independently represent —CH₃ or —CH₂CH₃;
R⁷ represents H, —CH₃, —CH₂CH₃ or —CH₂—C₆H₅;
X¹— represents a monovalent anion, such as Cl—, SCN—, CH₃SO₃— and Br—,
to the exclusion of compound of formula (I);
(5) from 0 to 50 parts by weight of at least one monomer of formula (V): 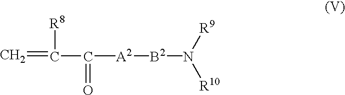
in which:
R⁸ represents H or —CH₃;
A² represents —O— or —NH—;
B² represents —CH₂—CH₂—, —CH₂CH₂CH₂—, —CH₂—CHOH—CH₂—;
R⁹ and R¹⁰ each independently represent —CH₃ or —CH₂CH₃;
(6) from 0 to 80 parts by weight of at least one monomer having a carboxyl function.

8. - Cationic copolymer according to claim 7, characterized in that the monomer of formula (I) represents from 5 to 60 parts by weight per 100 parts by weight of the monomer composition.
